(19) United States
(12) Patent Application Publication
(10) Pub. No.: US 2014/0204053 A1
(43) Pub. Date: Jul. 24, 2014

(54) CONCURRENT DRIVING CAPACITIVE TOUCH SENSING DEVICE AND TRANSMISSION SYSTEM

(71) Applicant: PixArt Imaging Inc., Hsin-Chu County (TW)

(72) Inventor: Kenneth C. CRANDALL, Sunnyvale, CA (US)

(21) Appl. No.: 13/928,105

(22) Filed: Jun. 26, 2013

Related U.S. Application Data
(63) Continuation-in-part of application No. 13/746,883, filed on Jan. 22, 2013.

(51) Int. Cl. G06F 3/044

(52) U.S. Cl. CPC G06F 3/044
USPC 345/174

(57) ABSTRACT

There is provided a concurrent driving capacitive touch sensing device including a drive end, a capacitive sensing matrix and a detection end. The drive end simultaneously inputs encoded and modulated drive signals into a plurality of channels of the capacitive sensing matrix within each drive time slot of a frame. The detection end detects a detection matrix of the channels in the frame and decodes the detection matrix so as to generate a two-dimensional detection vector corresponding to each of the channels.

### CROSS REFERENCE TO RELATED APPLICATION

This application is a continuation in part application of U.S. Ser. No. 13/746,883 filed Jan. 22, 2013, the full disclosure of which is incorporated herein by reference.

### BACKGROUND

1. Field of the Disclosure

This disclosure generally relates to a transmission system and, more particularly, to a concurrent driving capacitive touch sensing device.

2. Description of the Related Art

Capacitive sensors generally include a pair of electrodes configured to sense a finger. When a finger is present, the amount of charge transfer between the pair of electrodes can be changed so that it is able to detect whether a finger is present or not according to a voltage variation. It is able to form a sensing matrix by arranging a plurality of electrode pairs in matrix.

FIGS. 1A and 1B show schematic diagrams of the conventional capacitive sensor which includes a first electrode 91, a second electrode 92, a drive circuit 93 and a detection circuit 94. The drive circuit 93 is configured to input a drive signal to the first electrode 91. Electric field can be produced between the first electrode 91 and the second electrode 92 so as to transfer charges to the second electrode 92. The detection circuit 94 is configured to detect the amount of charge transfer to the second electrode 92.

When a finger is present, e.g. shown by an equivalent circuit 8, the finger may disturb the electric field between the first electrode 91 and the second electrode 92 so that the amount of charge transfer is reduced. The detection circuit 94 can detect a voltage variation to accordingly identify the presence of the finger.

Principles of the conventional active capacitive sensor may be referred to U.S. Patent Publication No. 2010/0096193 and U.S. Pat. No. 6,452,514.

Referring to FIG. 1C, the detection circuit 94 generally includes a detection switch 941 and a detection unit 942, wherein the detection unit 942 can detect a voltage value on the second electrode 92 only within the on-period of the detection switch 941. However, signal lines of the sensing matrix in different touch panels can have different capacitances, and the drive signal inputted by the drive circuit 93 can have different phase shifts corresponding to different sensing matrices. Therefore, the on-state of the detection switch 941 has to be adjusted corresponding to different touch panels or it is not able to detect correct voltage values. And this adjustment process can increase the manufacturing complexity.

Accordingly, the present disclosure provides a concurrent driving capacitive touch sensing device and a transmission system capable of overcoming the influence of the phase shift.

### SUMMARY

The present disclosure provides a capacitive touch sensing device and a detection method thereof that utilize two continuous signals to respectively modulate a detection signal so as to eliminate the interference from the phase shift caused by signal lines of the sensing matrix.

The present disclosure further provides a concurrent driving capacitive touch sensing device and a transmission system that may detect every channel several times in a transmission frame so as to increase the signal-to-noise ratio.

The present disclosure provides a capacitive touch sensing device including a first electrode, a second electrode, a drive unit, a detection circuit and a processing unit. The first electrode and the second electrode are configured to form a coupling capacitance therebetween. The drive unit is configured to input a drive signal to the first electrode. The detection circuit is coupled to the second electrode and configured to detect a detection signal coupled to the second electrode from the drive signal through the coupling capacitance and to modulate the detection signal respectively with two signals to generate a two-dimensional detection vector. The processing unit is configured to calculate a norm of vector of the two-dimensional detection vector and to compare the norm of vector with a threshold so as to identify a touch event.

The present disclosure further provides a detection method of a capacitive touch sensing device, which includes a sensing element having a first electrode and a second electrode configured to form a coupling capacitance therebetween. The detection method includes the steps of: inputting a drive signal to the first electrode of the sensing element; modulating a detection signal coupled to the second electrode from the drive signal through the coupling capacitance respectively with two signals so as to generate a pair of modulated detection signals; and calculating a scale of the pair of the modulated detection signals to accordingly identify a touch event.

The present disclosure further provides a capacitive touch sensing device that includes a capacitive sensing matrix, a plurality of drive units, a detection circuit and a processing unit. The capacitive sensing matrix includes a plurality of sensing elements arranged in matrix and each of the sensing elements has a first electrode and a second electrode configured to form a coupling capacitance therebetween. The plurality of drive units are coupled to the first electrode of the sensing elements and configured to sequentially output a drive signal to the first electrode. The detection circuit is coupled to the second electrode of the sensing elements and configured to sequentially detect a detection signal coupled to the second electrode from the drive signal through the coupling capacitance and to modulate the detection signal respectively with two signals so as to generate a pair of modulated detection signals. The processing unit is configured to identify a touch event and a touch position according to the pair of the modulated detection signals.

The present disclosure further provides a concurrent driving capacitive touch sensing device including a drive unit, a capacitive sensing matrix, an encoding unit, a modulation unit, a detection circuit and a decoding unit. The drive unit is configured to output a drive signal. The capacitive sensing matrix includes a plurality of sensing elements arranged in rows and columns. The encoding unit is configured to encode the drive signal corresponding to each row of the sensing elements so as to output encoded drive signals. The modulation unit is configured to modulate the encoded drive signals corresponding to each row of the sensing elements so as to simultaneously output encoded and modulated drive signals to each row of the sensing elements. The detection circuit is coupled to the capacitive sensing matrix and configured to output a detection matrix according to a detection signal of each column of the sensing units. The decoding unit is configured to decode the detection matrix so as to output a two-dimensional detection vector corresponding to each of the sensing elements.

The present disclosure further provides a concurrent driving capacitive touch sensing device including a capacitive sensing matrix, a drive end and a detection end. The capacitive sensing matrix has a plurality of channels. The drive end is configured to simultaneously input encoded and modulated drive signals into the channels in each drive time slot of a plurality of drive time slots of a frame. The detection end is configured to sequentially couple to the channels of the capacitive sensing matrix, decode a detection matrix formed by detecting the channels so as to generate a two-dimensional detection vector corresponding to each of the channels and calculate a norm of vector of the two-dimensional detection vector.

The present disclosure further provides a transmission system including a transmitting end, a synchronization means and a detection end. The transmitting end includes a plurality of mobile elements, a plurality of encoding units and a plurality of emitting units. Each of the mobile elements is configured to output a modulated transmission signal. The encoding units are associated with each of the mobile devices and configured to encode the modulated transmission signal to output encoded and modulated transmission signals. The emit units are associated with each of the mobile devices and configured to simultaneously emit the encoded and modulated transmission signals of the mobile elements in each time slot of a plurality of time slots of a transmission frame. The synchronization means is for synchronizing the time slots of the encoded and modulated transmission signals of the different mobile devices. The detection end includes a receiving unit and a decoding unit. The decoding unit is configured to receive the encoded and modulated transmission signals corresponding to each of the time slots and generate a detection matrix. The decoding unit is configured to decode the detection matrix so as to generate a received signal corresponding to each of the mobile elements.

In one aspect, it is able to use a Hadamard matrix to perform the encoding process and use an inverse Hadamard matrix of the Hadamard matrix to perform the decoding process.

In one aspect, it is able to only use phase modulation to perform the signal modulation, or it is able to use both phase modulation and amplitude modulation to perform the signal modulation.

In one aspect, the norm of vector may be calculated by a coordinate rotation digital computer (CORDIC).

In one aspect, the two signals are continuous signals, such as two continuous signals orthogonal or non-orthogonal to each other For example, the two signals may include a sine signal and a cosine signal having a phase difference therebetween equal to, larger than or smaller then zero degree.

In one aspect, the drive signal may be a time-varying signal, such as a periodic signal.

In one aspect, the detection circuit further includes at least one integrator and at least one analog-to-digital converter; the integrator is configured to integrate the detection signal being modulated; and the analog-to-digital converter is configured to digitize the detection signal being modulated and integrated so as to generate two components of the two-dimensional detection vector.

In the capacitive touch sensing device according to the embodiment of the present disclosure, when an object is present close to the sensing element, the norm of vector may become larger or become smaller. Therefore, by comparing the norm of vector with a threshold, it is able to identify that whether the object is present close to the sensing element. And because the norm of vector is a scalar, it is able to eliminate the interference caused by the phase shift of signal lines in the sensing matrix thereby improving the detection accuracy.

### BRIEF DESCRIPTION OF THE DRAWINGS

Other objects, advantages, and novel features of the present disclosure will become more apparent from the following detailed description when taken in conjunction with the accompanying drawings.

FIGS. 1A-1C show schematic diagrams of the conventional active capacitive sensor.

FIG. 2 shows a schematic diagram of the capacitive touch sensing device according to an embodiment of the present disclosure.

FIGS. 3A-3B show other schematic diagrams of the capacitive touch sensing device according to an embodiment of the present disclosure.

FIG. 4 shows a schematic diagram of the norm of vector and the threshold used in the capacitive touch sensing device according to the embodiment of the present disclosure.

FIG. 5 shows a schematic diagram of the capacitive touch sensing device according to another embodiment of the present disclosure.

FIG. 6 shows a flow chart of the operation of the capacitive touch sensing device shown in FIG. 5.

FIG. 7 shows a schematic diagram of the concurrent driving capacitive touch sensing device according to an embodiment of the present disclosure.

FIG. 8 shows a schematic diagram of drive signals of every channel in every drive time slot of the concurrent driving capacitive touch sensing device according to the embodiment of the present disclosure.

FIG. 9 shows a schematic block diagram of the transmission system according to an embodiment of the present disclosure.

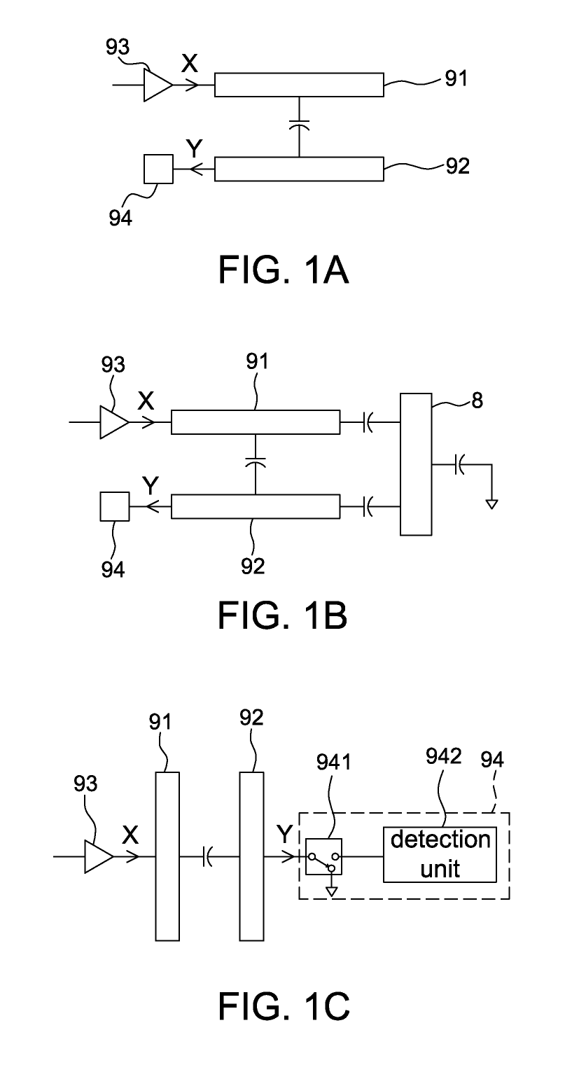

### DETAILED DESCRIPTION OF THE EMBODIMENT

It should be noted that, wherever possible, the same reference numbers will be used throughout the drawings to refer to the same or like parts.

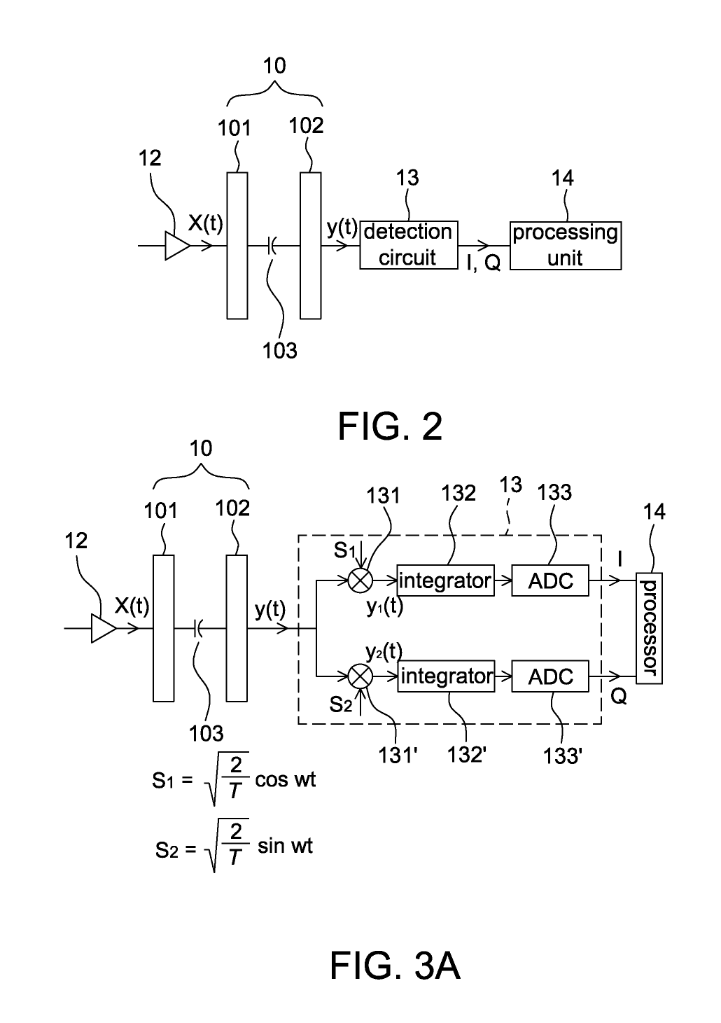

Referring to FIG. 2, it shows a schematic diagram of the capacitive touch sensing device according to an embodiment of the present disclosure. The capacitive touch sensing device of this embodiment includes a sensing element 10, a drive unit 12, a detection circuit 13 and a processing unit 14. The capacitive touch sensing device is configured to detect whether an object (e.g. a finger or a metal plate, but mot limited to) approaches the sensing element 10 according to the change of the amount of charges on the sensing element 10.

The sensing element 10 includes a first electrode 101 (e.g. a drive electrode) and a second electrode 102 (e.g. a receiving electrode), and electric field can be produced to form a coupling capacitance 103 between the first electrode 101 and the second electrode 102 when a voltage signal is inputted to the first electrode 101. The first electrode 101 and the second electrode 102 may be arranged properly without any limitation as long as the coupling capacitance 103 can be formed (e.g. via a dielectric layer), wherein principles of forming the electric field and the coupling capacitance 103 between the first electrode 101 and the second electrode 102 is well know and thus are not described herein. The spirit of the present disclosure is to eliminate the interference on detecting results due to the phase shift caused by the capacitance on signal lines.

The drive unit 12 may be a signal generator and configured to input a drive signal x(t) to the first electrode 101 of the sensing element 10. The drive signal x(t) may be a time-varying signal, such as a periodic signal. In other embodiments, the drive signal x(t) may be a pulse signal, such as a square wave or a triangle wave, but not limited thereto. The drive signal x(t) may couple a detection signal y(t) on the second electrode 102 through the coupling capacitance 103.

The detection circuit 13 is coupled to the second electrode 102 of the sensing element 10 and configured to detect the detection signal y(t) and to modulate the detection signal y(t) respectively with two signals so as to generate a pair of modulated detection signals, which are served as two components I and Q of a two-dimensional detection vector. The two signals may be continuous signals or vectors that are orthogonal or non-orthogonal to each other. In one aspect, the two signals include a sine signal and a cosine signal, wherein a phase difference between the sign signal and the cosine signal may or may not be 0.

The processing unit 14 is configured to calculate a scale of the pair of the modulated detection signals, which is served as a norm of vector of the two-dimensional detection vector (I,Q), and to compare the norm of vector with a threshold TH so as to identify a touch event. In one aspect, the processing unit 14 may calculate the norm of vector R=\sqrt{I²+Q²} by using software. In other aspect, the processing unit 14 may calculate by hardware or firmware, such as using the CORDIC (coordinate rotation digital computer) shown in FIG. 4 to calculate the norm of vector R=\sqrt{i²+q²}, wherein the CORDIC is a well known fast algorithm. For example, when there is no object closing to the sensing element 10, the norm of vector calculated by the processing unit 14 is assumed to be R; and when an object is present nearby the sensing element 10, the norm of vector is decreased to R′. When the norm of vector R′ is smaller than the threshold TH, the processing unit 14 may identify that the object is present close to the sensing element 10 and induces a touch event. It should be mentioned that when another object, such as a metal plate, approaches the sensing element 10, the norm of vector R may be increased. Therefore, the processing unit 14 may identify a touch event occurring when the norm of vector becomes larger than a predetermined threshold.

In another embodiment, the processing unit 14 may perform coding on the two components I and Q of the two-dimensional detection vector by using quadrature amplitude-shift keying (QASK), such as 16-QASK. A part of the codes may be corresponded to the touch event and the other part of the codes may be corresponded to non-touch state and these codes are previously saved in the processing unit 14. When the processing unit 14 calculates the QASK code of two current components I and Q according to the pair of the modulated detection signals, it is able to identify that whether an object is present near the sensing element 10.

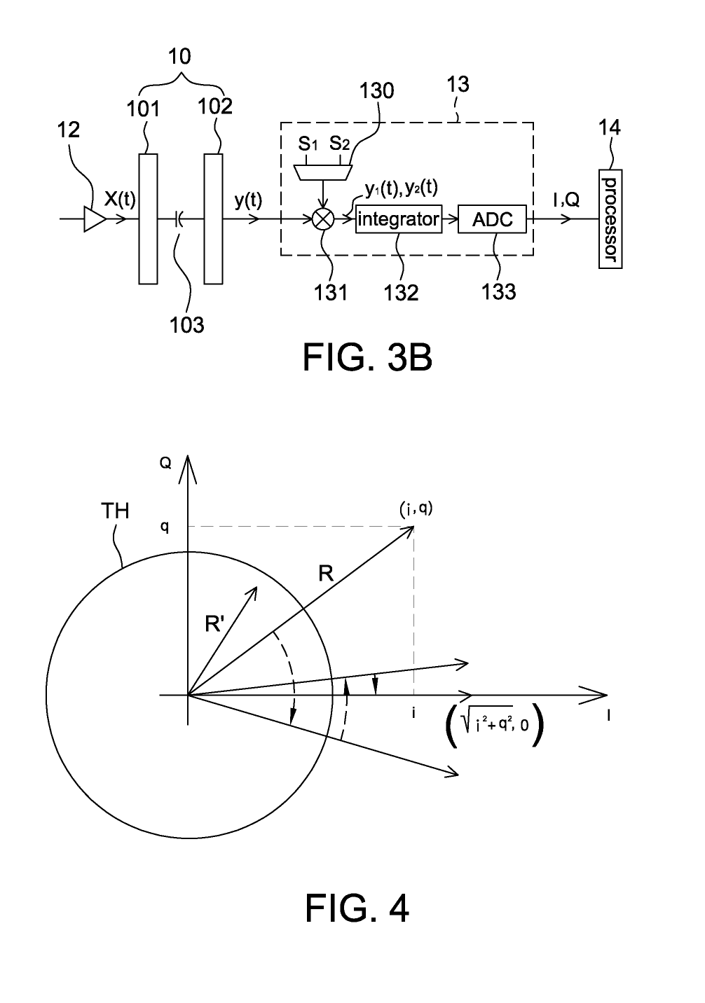

FIGS. 3A and 3B respectively show another schematic diagram of the capacitive touch sensing device according to an embodiment of the present disclosure in which embodiments of the detection circuit 13 are shown.

In FIG. 3A, the detection circuit 13 includes two multipliers 131 and 131′, two integrators 132 and 132′, two analog-to-digital converters (ADC) 133 and 133′ configured to process the detection signal y(t) so as to generate a two-dimensional detection vector (I,Q). The two multipliers 131 and 131′ are indicated to module two signals, such as S₁=\sqrt{2/T cos(ωt)} and S₂=\sqrt{2/T sin(ωt)} herein, with the detection signal y(t) so as to generate a pair of modulated detection signals y₁(t) and y₂(t). In order to sample the pair of the modulated detection signals y₁(t) and y₂(t), two integrators 132 and 132′ are configured to integrate the pair of the modulated detection signals y₁(t) and y₂(t). In this embodiment, the two integrators 132 and 132′ may be any proper integration circuit, such as the capacitor. The two ADC 133 and 133′ are configured to digitize the pair of the modulated detection signals y₁(t) and y₂(t) being integrated so as to generate two digital components I and Q of the two-dimensional detection vector. It is appreciated that the two ADC 133 and 133′ start to acquire digital data when voltages on the two integrators 132 and 132′ are stable. In addition to the two continuous signals mentioned above may be used as the two signals, the two signals may also be two vectors, for example S₁=[1 0 −1 0] and S₂=[0 −1 0 1] so as to simplify the circuit structure. The two signals may be proper simplified vectors without any limitation as long as the used vectors may simplify the processes of modulation and demodulation.

In FIG. 3B, the detection circuit 13 includes a multiplier 131, an integrator 132 and an analog-to-digital converter 133, and the two signals S₁ and S₂ are inputted to the multiplier 131 via a multiplexer 130 to be modulated with the detection signal y(t) so as to generate two modulated detection signals y₁(t) and y₂(t). In addition, functions of the multiplier 131, the integrator 132 and the ADC 133 are similar to those shown in FIG. 3A and thus details thereof are not described herein.

As mentioned above, the detection method of the capacitive touch sensing device of the present disclosure includes the steps of: inputting a drive signal to a first electrode of a sensing element; modulating a detection signal coupled to a second electrode from the drive signal through a coupling capacitance respectively with two signals so as to generate a pair of modulated detection signals; and calculating a scale of the pair of the modulated detection signals to accordingly identify a touch event.

Referring to FIGS. 3A and 3B for example, the drive unit 12 inputs a drive signal x(t) to the first electrode 101 of the sensing element 10, and the drive signal x(t) may couple a detection signal y(t) on the second electrode 102 of the sensing element 10 through the coupling capacitance 103. Next, the detection circuit 13 respectively modulates the detection signal y(t) with two signals S₁ and 5₂ to generate a pair of modulated detection signals y₁(t) and y₂(t). The processing unit 14 calculates a scale of the pair of the modulated detection signals y₁(t) and y₂(t) to accordingly identify a touch event, wherein the method of calculating the scale of the pair of the modulated detection signals y₁(t) and y₂(t) may be referred to FIG. 4 and its corresponding descriptions. In addition, before calculating the scale of the pair of the modulated detection signals y₁(t) and y₂(t), the integrator 132 and/or 132′ may be used to integrate the pair of the modulated detection signals y₁(t) and y₂(t) and then the ADC 133 and/or 133′ may be used perform the digitization so as to output the two digital components I and Q of the two-dimensional detection vector (I,Q).

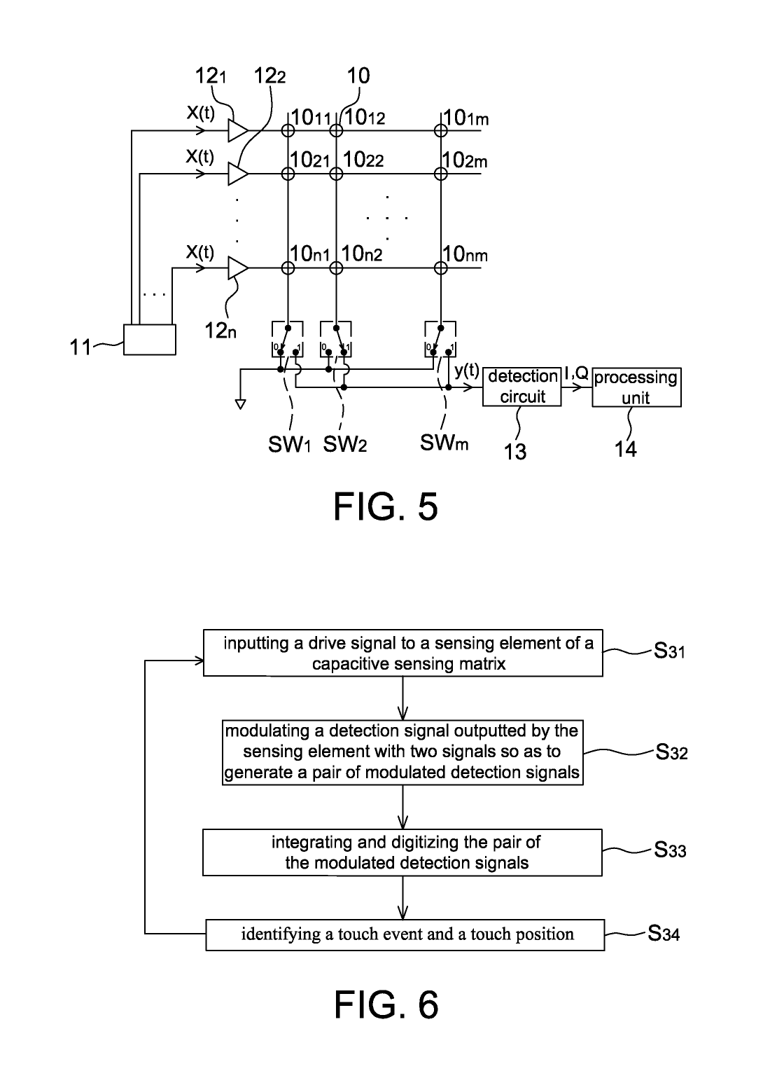

Referring to FIG. 5, it shows a schematic diagram according to another embodiment of the present disclosure. A plurality of sensing elements 10 arranged in matrix may form a capacitive sensing matrix in which every row of the sensing elements 10 is driven by one of the drive units 12₁-12ₙ and the detection circuit 13 detects output signals of every column of the sensing elements 10 through one of the switch devices SW₁-SWₘ. As shown in FIG. 5, the drive unit 12₁ is configured to drive the first row of sensing elements 10₁₁-10₁ₘ; the drive unit 12₂ is configured to drive the second row of sensing elements 10₂₁-10₂ₘ; . . . ; and the drive unit 12ₙ is configured to drive the nth row of sensing elements 10ₙ₁-10ₙₘ; wherein, n and m are positive integers and the value thereof may be determined according to the size and resolution of the capacitive sensing matrix without any limitation.

In this embodiment, each of the sensing elements 10 (shown by circles herein) include a first electrode and a second electrode configured to form a coupling capacitance therebetween as shown in FIGS. 2, 3A and 3B. The drive units 12₁-12ₙ are respectively coupled to the first electrode of a row of the sensing elements 10. A timing controller 11 is configured to control the drive units 12₁-12ₙ to sequentially output a drive signal x(t) to the first electrode of the sensing elements 10.

The detection circuit 13 is coupled to the second electrode of a column of the sensing elements 10 through a plurality of switch devices SW₁-SWₘ to sequentially detect a detection signal y(t) coupled to the second electrode from the drive signal x(t) through the coupling capacitance of the sensing elements 10. The detection circuit 13 utilizes two signals to respectively modulate the detection signal y(t) to generate a pair of modulated detection signals, wherein details of generating the pair of the modulated detection signals has been described in FIGS. 3A and 3B and their corresponding descriptions and thus are not repeated herein.

The processing unit 14 identifies a touch event and a touch position according to the pair of the modulated detection signals. As mentioned above, the processing unit 14 may calculate a norm of vector of a two-dimensional detection vector of the pair of the modulated detection signals and identifies the touch event when the norm of vector is larger than or equal to, or smaller than or equal to a threshold TH as shown in FIG. 4.

In this embodiment, when the timing controller 11 controls the drive unit 12₁ to output the drive signal x(t) to the first row of the sensing elements 10₁₁-10₁ₘ, the switch devices SW₁-SWₘ are sequentially turned on such that the detection circuit 13 may detect the detection signal y(t) sequentially outputted by each sensing element of the first row of the sensing elements 10ₙ-10₁ₘ. Next, the timing controller 11 sequentially controls other drive units 122-12n to output the drive signal x(t) to every row of the sensing elements. When the detection circuit 13 detects all of the sensing elements once, a scan period is accomplished. The processing unit 14 identifies the position of the sensing elements that the touch event occurs as the touch position. It is appreciated that said touch position may be occurred on more than one sensing elements 10 and the processing unit 14 may take all positions of a plurality of sensing elements 10 as touch positions or take one of the positions (e.g. the center or gravity center) of a plurality of adjacent sensing elements 10 as the touch position.

Referring to FIG. 6, it shows a flow chart of the operation of the capacitive sensing device shown in FIG. 5, which includes the steps of: inputting a drive signal to a sensing element of a capacitive sensing matrix (Step S₃₁); respectively modulating a detection signal outputted by the sensing element with two signals so as to generate a pair of modulated detection signals (Step S₃₂); integrating and digitizing the pair of the modulated detection signals (Step S₃₃); and identifying a touch event and a touch position (Step S₃₄). Details of the operation of this embodiment have been described in FIG. 5 and its corresponding descriptions and thus are not repeated herein.

In another aspect, in order to save the power consumption of the capacitive touch sensing device shown in FIG. 5, the timing controller 11 may control more than one drive units 12₁-12ₙ to simultaneously output the drive signal x(t) to the associated row of the sensing elements. The detection circuit 13 respectively modulates the detection signal y(t) of each row with different two continuous signals S₁ and S₂ for distinguishing. In addition, the method of identifying the touch event and the touch position are similar to FIG. 5 and thus details thereof are not repeated herein.

In the embodiment of the present disclosure, the detection circuit 13 may further include the filter and/or the amplifier to improve the signal quality. In addition, the processing unit 14 may be integrated with the detection circuit 13.

As mentioned above, the phase shift during signal transmission caused by the capacitance on signal lines may be ignored by calculating the norm of vector of a two-dimensional detection vector. In other words, if a phase shift exists between drive signals x(t) of every channel, the phase shift may also be ignored by calculating the norm of vector. Therefore in an alternative embodiment of the present disclosure, it is able to concurrently drive different channels in the same drive time slot with a plurality of drive signals having phase shift from each other, and to identify a touch event and/or a touch position by calculating a norm of vector of the two-dimensional detection vector of every channel in the receiving end. In addition, as the phase modulation of different channels is implemented on the drive signal x(t), in the receiving end it is no longer necessary to use two signals to modulate the detection signal y(t) respectively. Details of this embodiment are described hereinafter.

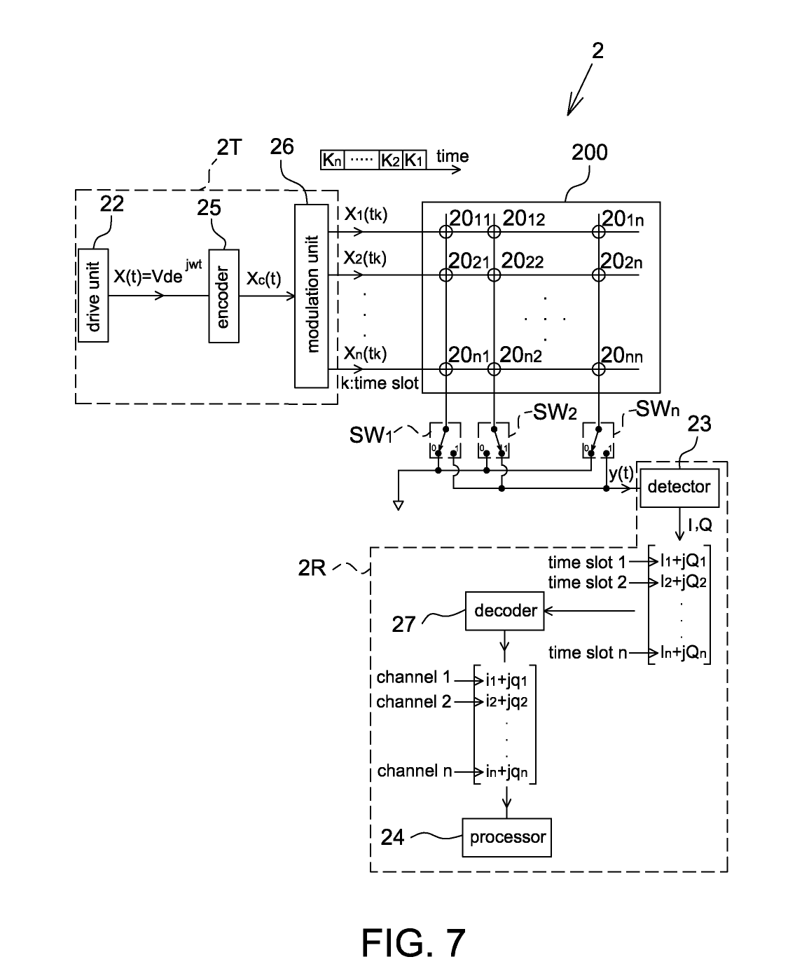

Referring to FIG. 7, it shows a concurrent driving capacitive touch sensing device 2 according to an embodiment of the present disclosure. The concurrent driving capacitive touch sensing device 2 includes a drive end 2T, a capacitive sensing matrix 200 and a detection end 2R, wherein the capacitive sensing matrix 200 has a plurality of channels. For example, the capacitive sensing matrix 200 includes a plurality of sensing elements (e.g. 20₁₁˜20ₙₙ) arranged in rows and columns, and said channel herein is referred to a signal path between the drive end 2T, the detection end 2R and a sensing element, which is driven by the drive end 2T and detected by the detection end 2R, therebetween.

The drive end 2T is configured to simultaneously input encoded and modulated drive signals to the channels in each drive time slot of a plurality of drive time slots of a scan period (or a frame) of the capacitive sensing matrix 200. The detection end 2R is sequentially coupled to the channels of the capacitive sensing matrix 200, and configured to decode a detection matrix, which is obtained by detecting the channels, so as to generate a two-dimensional detection vector corresponding to each of the channels and calculate a norm of vector of the two-dimensional detection vector, wherein each matrix element of the detection matrix is a detection signal obtained in each of the drive time slots and the detection matrix is a one-dimensional matrix. In addition, the detection end 2R further compares the norm of vector with a threshold so as to identify a touch event and/or a touch position (as shown in FIG. 4). In one aspect, a number of the drive time slots is equal to a number of the channels.

In this embodiment, the encoded and modulated drive signals may be encoded by using a Hadamard matrix, and the detection end 2R may decode the detection matrix using an inverse Hadamard matrix of the Hadamard matrix. The encoded and modulated drive signals may only be phase modulated or may be phase and amplitude modulated, e.g. using quadrature amplitude modulation.

In one embodiment, the concurrent driving capacitive touch sensing device 2 includes a drive unit 22, an encoding unit 25, a modulation unit 26, the capacitive sensing matrix 200, a detection circuit 23, a decoding unit 27 and a processing unit 24. In one embodiment, the drive unit 22, the encoding unit 25 and the modulation unit 26 may be combined to form the drive end 2T; and the detection circuit 23, the decoding unit 27 and the processing unit 24 may be combined to form the detection end 2R.

In another embodiment, the encoding unit 25 and the modulation unit 26 may be combined to form a single encoding and modulation unit; and the decoding unit 27 may be integrated with the processing unit 24.

The drive unit 22 is configured to output a drive signal X(t) to the encoding unit 25, e.g. X(t)=Vd×exp(jwt), wherein Vd indicates a drive voltage value, w indicates a drive frequency and t indicates time. As described in the previous embodiment, the drive signal X(t) is not limited to a continuous signal. In another embodiment, the drive unit 22 may output a plurality of identical drive signals to the encoding unit 25.

The encoding unit 25 is configured to encode the drive signal X(t) conesponding to each row of the sensing elements so as to output an encoded drive signal Xc(t). In one embodiment, the encoding unit 25 encodes the drive signal X(t) using an encoding matrix, e.g. a Hadamard matrix. It is appreciated that as long as every channel may be distinguished by encoding, other encoding matrices may be used. In addition, the size of the encoding matrix may be determined by the number of channels.

The modulation unit 26 is configured to perform the phase modulation on the encoded drive signal Xc(t) conesponding to each row of the sensing elements so as to output encoded and modulated drive signals to each row of the sensing elements, and said phase modulation is configured to allow the encoded and modulated drive signals inputted into each row of the sensing elements to have a phase shift from each other. In this manner, it is able to decrease the input voltage of the analog-to-digital (ADC) converter in the detection circuit 23 (as FIGS. 3A and 3B) so as not to exceed a detection range of the ADC converter. In other embodiments, the encoded drive signal Xc(t) may also be amplitude and phase modulated, e.g. using quadrature amplitude modulation. For example in FIG. 7, the modulation unit 26 outputs an encoded and modulated drive signal X₁(tₖ) to the first channel, an encoded and modulated drive signal X₂(tₖ) to the second channel . . . and an encoded and modulated drive signal Xₙ(tₖ) to the nth channel, wherein k is referred to a drive time slot in a scan period herein.

For example, the encoding matrix may use equation (1) as an example and each matrix element may be indicated by aᵣₛ, wherein the subscript “r” of each matrix element aᵣₛ is associated with each drive time slot and the subscript “s” of each matrix element aᵣₛ is associated with each channel.

$$[ \begin{matrix}{a}_{11} & {a}_{12} & … & {a}_{1 n} \\ {a}_{21} & {a}_{22} & … & {a}_{2 n} \\ & & ⋱ & \\ {a}_{n 1} & {a}_{n 2} & … & {a}_{nn}\end{matrix} ] \qquad ( 1 )$$

The operation of the modulation unit 26 may be represented mathematically by a diagonal matrix shown in equation (2), wherein x₁ to xₙ are complex numbers and preferably have a phase shift from each other. x₁ to xₙ are configured to perform the phase modulation on different channels respectively. When the quadrature amplitude modulation (QAM) is used as a modulation mechanism, x₁ to xₙ have an amplitude shift and a phase shift from each other, wherein the subscript of x₁ to xₙ is associated with each channel.

$$[ \begin{matrix}{x}_{1} & 0 & … & 0 \\ 0 & {x}_{2} & … & 0 \\ & & ⋱ & \\ 0 & 0 & … & {x}_{n}\end{matrix} ] \qquad ( 2 )$$

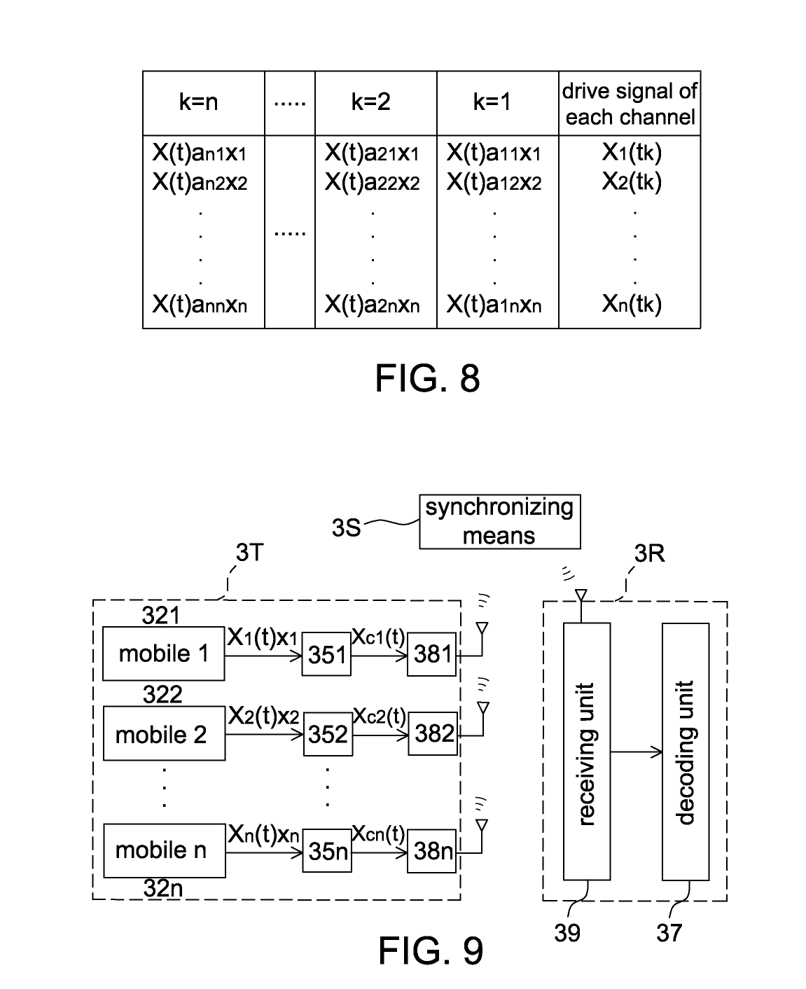

Referring to FIGS. 7 and 8, based on equations (1) and (2), the modulation unit 26 may simultaneously output a drive signal X(t)a₁₁x₁ to the first channel, a drive signal X(t)a₁₂x₂ to the second channel . . . and a drive signal X(t)a₁ₙxₙ to the nth channel in the first time slot k=1. The modulation unit 26 may simultaneously output a drive signal X(t)a₂₁x₁ to the first channel, a drive signal X(t)a₂₂x₂ to the second channel . . . and a drive signal X(t)a₂ₙxₙ to the nth channel in the second time slot k=2. The modulation unit 26 may simultaneously output a drive signal X(t)aₙ₁x₁ to the first channel, a drive signal X(t)aₙ₂x₂ to the second channel . . . and a drive signal X(t)aₙₙxₙ to the nth channel in the nth time slot k=n. After the encoded and modulated drive signals X₁(tₖ) to Xₙ(tₖ) of all time slots k=1 to k=n are inputted into the capacitive sensing matrix 200, the operation of one drive frame is accomplished.

As mentioned above, the capacitive sensing matrix 200 includes a first row of sensing elements 20₁₁ to 20₁ₙ, a second row of sensing elements 20₂₁ to 20₂ₙ, . . . and a nth row of sensing elements 20ₙ₁ to 20ₙₙ (i.e. channels 1 to n). The drive signals X(t)a₁₁x₁, X(t)a₁₂x₂, . . . X(t)a₁ₙxₙ are respectively inputted into the first row of sensing elements 20₁₁ to 20₁ₙ, the second row of sensing elements 20₂₁ to 20₂ₙ, . . . and the nth row of sensing elements 20ₙ₁ to 20ₙₙ in the first time slot k=1. The drive signals inputted into each row of the sensing elements in other time slots k=2 to k=n are also shown in FIG. 8. In addition, lines of the capacitive sensing matrix 200 have different reactance with respect to different channels, and an one-dimensional matrix [y₁ y₂ . . . yₙ]^{T} may be used to represent the reactance matrix of capacitive sensing matrix 200 mathematically. In one scan period, if the capacitive sensing matrix 200 is not touched, the reactance matrix is substantially unchanged; whereas when a touch occurs, at least one matrix element of the reactance matrix is changed such that the detection signal y(t) is changed accordingly.

As shown in FIG. 7, each column of the sensing elements of the capacitive sensing matrix 200 is coupled to the detection circuit 23 via a respective switch device SW₁ to SWₙ. With each drive time slot k=1 to k=n of one scan period, the switch devices SW₁ to SWₙ sequentially couple a corresponded column of the sensing elements to the detection circuit 23 to allow the detection circuit 23 to generate a detection matrix according to a detection signal y(y) of each column of the sensing elements. For example FIG. 7 shows that the switch device SW₂ couples the second column of the sensing elements of the capacitive sensing matrix 200 to the detection circuit 23.

Therefore, after one scan period (i.e. one frame), the detection signal y(t) from every column of the sensing elements of the capacitive sensing matrix 200 may be represented by X(t)×[encoding matrix]×[modulation matrix]×[reactance matrix] as shown in equation (3) mathematically, wherein matrix elements of the encoding matrix may be determined according to the encoding method being used; matrix elements of the modulation matrix may be determined according to the modulation mechanism being used; and matrix elements of the reactance matrix may be determined according to the capacitive sensing matrix 200. As mentioned above, the detection circuit 23 includes at least one integrator and at least one ADC converter (as shown in FIGS. 3A and 3B) configured to obtain two digital components I and Q of the two-dimensional detection vector (I+jQ) according to the detection signal y(t).

$$y ( t ) = x ( t ) \times [ \begin{matrix}{a}_{11} & {a}_{12} & … & {a}_{1 n} \\ {a}_{21} & {a}_{22} & … & {a}_{2 n} \\ & & ⋱ & \\ {a}_{n 1} & {a}_{n 2} & … & {a}_{nn}\end{matrix} ] \times [ \begin{matrix}{x}_{1} & 0 & … & 0 \\ 0 & {x}_{2} & … & 0 \\ & & ⋱ & \\ 0 & 0 & … & {x}_{n}\end{matrix} ] \times [ \begin{matrix}{y}_{1} \\ {y}_{2} \\ ⋮ \\ {y}_{n}\end{matrix} ] \qquad ( 3 )$$

Therefore, the two-dimensional detection vectors outputted by the detection circuit 23 after one scan period may be represented by a detection matrix [I₁+jQ₁)(I₂+jQ₂) . . . (Iₙ+jQₙ)]^{T}, wherein (I₁+jQ₁) is the two-dimensional detection vector obtained according to the detection signal y(t) of one column of (e.g. the second column) the sensing elements in the first drive time slot k=1. As the encoded and modulated drive signals X₁(tₖ) to Xₙ(tₖ) are respectively inputted into every channel in the first drive time slot k=1, the two-dimensional detection vector (I₁+jQ₁) contains the superposition of detection signals of all channels in the first drive time slot k=1. Similarly, (I₂+jQ₂) is the two-dimensional detection vector obtained according to the detection signal y(t) of one column of the sensing elements in the second drive time slot k=2 and contains the superposition of detection signals of all channels in the second drive time slot k=2; . . . ; (Iₙ+jQₙ) is the two-dimensional detection vector obtained according to the detection signal y(t) of one column of the sensing elements in the nth drive time slot k=n and contains the superposition of detection signals of all channels in the nth drive time slot k=n.

For decoupling the superposition of detection signals, the detection circuit 23 sends the detection matrix to the decoding unit 27 for decoding. The decoding unit 27 then outputs two-dimensional detection vectors of every channel (i.e. the sensing element) in one column of (e.g. the second column) the sensing elements as shown by equation (4). For example, the two-dimensional detection vector of channel 1 is represented by (i₁+jq₁), the two-dimensional detection vector of channel 2 is represented by (i₂+jq₂), . . . and the two-dimensional detection vector of channel n is represented by (iₙ+jqₙ), wherein i and q are two digital components of the two-dimensional detection vectors. In FIG. 7, after one scan period, the decoding unit 27 may output a set of two-dimensional detection vectors (i+jq) corresponding to every column of the sensing elements; i.e. n sets of [(i₁+jq₁) (i₂+jq₂) . . . (iₙ+jqₙ)]^{T}. The decoding unit 27 may use an inverse matrix of the encoding matrix to decouple the superposition of the detection signals (i.e. the detection matrix), e.g. using the inverse matrix of the Hadamard matrix.

$$[ \begin{matrix}{i}_{1} + {jq}_{1} \\ {i}_{2} + {jq}_{2} \\ ⋮ \\ {i}_{n} + {jq}_{n}\end{matrix} ] = {[ \begin{matrix}{I}_{1} + {jQ}_{1} \\ {I}_{2} + {jQ}_{2} \\ ⋮ \\ {I}_{n} + {jQ}_{n}\end{matrix} ] [ \begin{matrix}{a}_{11} & {a}_{12} & … & {a}_{1 n} \\ {a}_{21} & {a}_{22} & … & {a}_{2 n} \\ & & ⋱ & \\ {a}_{n 1} & {a}_{n 2} & … & {a}_{nn}\end{matrix} ]}^{T} \qquad ( 4 )$$

Finally, the processing unit 24 may calculate a norm of vector of the two-dimensional detection vector of every channel and compare the obtained norm of vector with a threshold TH as shown in FIG. 4.

In this manner, after one scan period, the processing unit 24 may identify a touch event and/or a touch position on the capacitive sensing matrix 200 according to a comparison result of comparing nxn norm of vectors and the threshold TH, wherein n is the size of the sensing matrix.

In addition, when the drive signal X(t) is also amplitude modulated in this embodiment, the processing unit 24 may further include a automatic level control (ALC) to eliminate the amplitude shift. For example, the control parameter of the ALC when the capacitive sensing matrix 200 is not pressed may be previously saved in the processing unit 24 (or an additional memory unit) to, for example, allow the detection results of every sensing element to be substantially identical. Accordingly, when a touch occurs, it is able to identify the touch event accurately.

In addition, as mentioned above, each of the sensing elements (20₁₁ to 20ₙₙ) may include a first electrode 101 and a second electrode 102 configured to form a coupling capacitance 103 (as shown in FIGS. 2, 3A and 3B). The encoded and modulated drive signals X₁(tₖ) to Xₙ(tₖ) are coupled to the first electrode 101. The detection circuit 23 is coupled to the second electrode 102 and configured to detect the detection signal y(t) coupled to the second electrode 102 from the encoded and modulated drive signals X₁(tₖ) to Xₙ(tₖ) through the coupling capacitance 103.

The concurrent transmission method of the present disclosure may further be applied to other transmission systems so as to replace the conventional time division multiplexing (TDM) transmission and increase the SNR. For example in a mobile radio system, the detection signal y(t) in equation (3) does not contain the modulation effect of the reactance matrix [y₁ y₂ . . . yₙ]^{T}. In addition, in the application of the capacitive sensing matrix, the modulation matrix is substantially identical in every frame. However in the application of the mobile radio system, the modulation matrix is replaced by modulation vectors of every mobile device. As the coupled mobile devices may be different in different frames, the modulation vectors of each frame are determined according to the coupled mobile devices; e.g. the modulation vectors x₁ to xₙ may be updated by every mobile device in every frame configured to modulate the outputted transmission signals therefrom. A plurality of mobile devices replace the drive unit 22 so as to output the respective transmission signals X₁(t) to Xₙ(t). In this case, the detection matrix of equation (3) may be replaced by equation (5) mathematically, wherein the subscript “r” of each matrix element aᵣₛ is associated with each mobile device and the subscript “s” of each matrix element aᵣₛ is associated with the transmission time slot of one frame.

$$y ( t ) = [ \begin{matrix}{X}_{1} ( t ) {x}_{1} & 0 & … & 0 \\ 0 & {X}_{2} ( t ) {x}_{2} & … & 0 \\ & & ⋱ & \\ 0 & 0 & … & {X}_{n} ( t ) {x}_{n}\end{matrix} ] \times [ \begin{matrix}{a}_{11} & {a}_{12} & … & {a}_{1 n} \\ {a}_{21} & {a}_{22} & … & {a}_{2 n} \\ & & ⋱ & \\ {a}_{n 1} & {a}_{n 2} & … & {a}_{nn}\end{matrix} ] \qquad ( 5 )$$

For example referring to FIG. 9, it shows a schematic block diagram of the transmission system according to an embodiment of the present disclosure, which includes a transmitting end 3T and a detection end 3R, wherein the transmitting end 3T corresponds to the drive end 2T of FIG. 7 and the detection end 3R corresponds to the detection end 2R of FIG. 7. In addition, in order to synchronize the transmission signals sent from the transmitting end 3T, the transmission system of this embodiment further includes a synchronizing means 3S, e.g. a global positioning system (GPS). In this embodiment, the synchronizing means 35 may be any suitable means as long as the time slots of the transmission signals are time aligned when reaching a receiving antenna, e.g. employing a central synchronization signal.

The transmitting end 3T includes a plurality of mobile devices 321 to 32n, a plurality of encoding units 351 to 35n and a plurality of emitting units 381 to 38n, and the encoded and modulated transmission signals of each mobile device are sent from an individual antenna thereof; i.e. each mobile device includes an encoding unit, an emitting unit and an antenna respectively. The detection end 3R includes a receiving unit 39, a decoding unit 37 and a receiving antenna.

Each of the mobile devices 321 to 32n outputs a modulated transmission signal X₁(t)x₁ to Xₙ(t)xₙ, wherein the modulated transmission signals X₁(t)x₁ to Xₙ(t)xₙ are phase modulated transmission signals, or phase and amplitude modulated transmission signals, e.g. modulated by using QAM. As mentioned above, the modulated vectors x₁ to xₙ may be updated by the mobile devices 321 to 32n in every transmission frame.

The encoding units 351 to 35n are configured to encode the modulated transmission signals X₁(t)x₁ to Xₙ(t)xₙ so as to output encoded and modulated transmission signals Xc1(t) to Xcn(t), wherein the encoding unit 35 may use a Hadamard matrix to perform the encoding process and the modulated transmission signals of each mobile device are encoded by different rows of the Hadamard matrix so as to be separated from other mobile devices in the detection end 3R. As mentioned above, the present disclosure is not limited to use the Hadamard matrix as long as the transmission signals of every channel may be distinguished by using a predetermined encoding matrix. The emitting units 381 to 38n emit the encoded and modulated transmission signals Xc1(t) to Xcn(t) of the mobile devices 321 to 32n through the individual antenna within each time slot without carrier phase synchronization. The time slots of the encoded and modulated transmission signals of different mobile devices may be accurately synchronized by the synchronizing means 35. All n encoded and modulated transmission signals Xc1(t) to Xcn(t) are linearly superposed over the RF links as they arrive at the receiving antenna.

The receiving unit 39 receives the encoded and modulated transmission signals Xc1(t) to Xcn(t) corresponding to each of the time slots from the receiving antenna and generates a detection matrix y(t) as shown in equation (5), wherein each matrix element of the detection matrix y(t) is a complex number. The decoding unit 37 is configured to decode the detection matrix y(t) so as to generate a received signal corresponding to each of the mobile devices 321 to 32n as mentioned in the capacitive touch sensing device of the previous embodiment, e.g. the decoding unit 37 may use an inverse Hadamard matrix to perform the decoding process. It is appreciated that if the encoding matrix is not a Hadamard matrix, the decoding unit 37 does not use the inverse Hadamard matrix but use an inverse matrix of the encoding matrix.

In this embodiment, a number of slots in a transmission frame sending the encoded and modulated transmission signals Xc(t) is preferably equal to the a number of the mobile devices 321 to 32n. In this embodiment, since the detection end 3R may receive the transmission signal of every channel for several times in each transmission frame, the signal-to-noise ratio is effectively improved.

As mentioned above, the conventional transmission system employs TDM to transmit signals such that the signal-to-noise is relatively low. Therefore, the present disclosure further provides a concurrent driving capacitive touch sensing device (FIG. 7) and a transmission system (FIG. 9) that input drive signals to each channel and read detection signals from each channel in every transmission time slot. As the duty cycle of every channel in each scan period is increased, the signal-to-noise ratio is effectively increased thereby increasing the identification accuracy.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A concurrent driving capacitive touch sensing device, comprising:
a drive unit configured to output a drive signal;
a capacitive sensing matrix comprising a plurality of sensing elements arranged in rows and columns;
an encoding unit configured to encode the drive signal corresponding to each row of the sensing elements so as to output encoded drive signals;
a modulation unit configured to modulate the encoded drive signals corresponding to each row of the sensing elements so as to simultaneously output encoded and modulated drive signals to each row of the sensing elements
a detection circuit coupled to the capacitive sensing matrix and configured to output a detection matrix according to a detection signal of each column of the sensing units; and
a decoding unit configured to decode the detection matrix so as to output a two-dimensional detection vector corresponding to each of the sensing elements.

2. The sensing device as claimed in claim 1, further comprising a processing unit configured to calculate a norm of vector of the two-dimensional detection vector.

3. The sensing device as claimed in claim 2, wherein the processing unit is further configured to compare the norm of vector with a threshold so as to identify at least one of a touch event and a touch position.

4. The sensing device as claimed in claim 1, wherein the encoding unit uses a Hadamard matrix to encode the drive signal.

5. The sensing device as claimed in claim 4, wherein the decoding unit uses an inverse matrix of the Hadamard matrix to decode the detection matrix.

6. The sensing device as claimed in claim 1, wherein the modulate unit modulates a phase of the encoded drive signals corresponding to each row of the sensing elements.

7. The sensing device as claimed in claim 1, wherein the modulate unit modulates the encoded drive signals corresponding to each row of the sensing elements using quadrature amplitude modulation.

8. The sensing device as claimed in claim 1, wherein the detection circuit is respectively coupled to each column of the sensing elements through a plurality of switch devices.

9. The sensing device as claimed in claim 1, wherein each of the sensing elements comprises a first electrode and a second electrode configured to form a coupling capacitance; the encoded and modulated drive signals are coupled to the first electrode and the detection circuit is coupled to the second electrode configured to detect the detection signal coupled to the second electrode from the encoded and modulated drive signals through the coupling capacitance.

10. A concurrent driving capacitive touch sensing device, comprising:
a capacitive sensing matrix comprising a plurality of channels;
a drive end configured to simultaneously input encoded and modulated drive signals into the channels in each drive time slot of a plurality of drive time slots of a frame; and
a detection end configured to sequentially couple to the channels of the capacitive sensing matrix, decode a detection matrix formed by detecting the channels so as to generate a two-dimensional detection vector corresponding to each of the channels and calculate a norm of vector of the two-dimensional detection vector.

11. The sensing device as claimed in claim 10, wherein the encoded and modulated drive signals are encoded by a Hadamard matrix and modulated by phase modulation.

12. The sensing device as claimed in claim 10, wherein the encoded and modulated drive signals are encoded by a Hadamard matrix and modulated by quadrature amplitude modulation.

13. The sensing device as claimed in claim 10, wherein the detection end is further configured to compare the norm of vector with a threshold so as to identify at least one of a touch event and a touch position.

14. The sensing device as claimed in claim 10, wherein a number of the drive time slots is equal to a number of the channels.

15. The sensing device as claimed in claim 10, wherein the encoded and modulated drive signals are encoded by a Hadamard matrix, and the detection end decodes the detection matrix using an inverse matrix of the Hadamard matrix.

16. The sensing device as claimed in claim 10, wherein each matrix element of the detection matrix is a detection signal of each of the drive time slots.

17. A transmission system, comprising:
a transmitting end, comprising:
a plurality of mobile elements, each of the mobile elements outputting a modulated transmission signal;
a plurality of encoding units associated with each of the mobile devices and configured to encode the modulated transmission signal to output encoded and modulated transmission signals; and
a plurality of emitting units associated with each of the mobile devices and configured to emit the encoded and modulated transmission signals of the mobile elements in each time slot of a plurality of time slots of a transmission frame;
a synchronization means for synchronizing the time slots of the encoded and modulated transmission signals of the different mobile devices; and
a detection end, comprising:
a receiving unit configured to receive the encoded and modulated transmission signals corresponding to each of the time slots and generate a detection matrix; and
a decoding unit configured to decode the detection matrix so as to generate a received signal corresponding to each of the mobile elements.

18. The transmission system as claimed in claim 17, wherein the encoding units encode the modulated transmission signal using a Hadamard matrix.

19. The transmission system as claimed in claim 18, wherein the decoding unit decodes the detection matrix using an inverse matrix of the Hadamard matrix.

20. The transmission system as claimed in claim 17, wherein the modulated transmission signal is a phase modulated transmission signal, or a phase and amplitude modulated transmission signal.
